(19) United States
(12) Patent Application Publication
(10) Pub. No.: US 2016/0225298 A1
(43) Pub. Date: Aug. 4, 2016

(54) Inflatable Display

(71) Applicant: Occasions Ltd, Kowloon (HK)

(72) Inventor: Alan Siu Lun Chan, Kowloon (HK)

(73) Assignee: Occasions Ltd.

(21) Appl. No.: 14/876,653

(22) Filed: Oct. 6, 2015

Related U.S. Application Data
(60) Provisional application No. 62/066,749, filed on Oct. 21, 2014.

(51) Int. Cl. G09F 19/02

(52) U.S. Cl. CPC G09F 19/02

(57) ABSTRACT

An inflatable display is disclosed. The inflatable display contains an inflatable outer shell, at least one fan providing a continuous air flow to inflate the inflatable outer shell, a motorized assembly disposed within the inflatable outer shell, a string comprising a first end and a second end, wherein the motorized assembly is configured to move the inflatable shell from a first position to a second position along the string, wherein the first position is closer to the first end than the second position.

### CROSS REFERENCE TO RELATED APPLICATIONS

This application claims the benefit of U.S. Provisional Application No. 62/066,749, filed on Oct. 21, 2014, which is incorporated herein by reference in its entirety.

### FIELD

The present invention relates to air-filed displays.

### BACKGROUND

Inflatable displays have a wide range of application, shape and size, including, but not limited to, figures for holiday and seasonal decoration, marketing, advertising, entertainment, and event attraction. The inflatable displays are made from a permeable fabric that allows air to pass through the fabric at approximately the same rate as the air being blown into the inflatable display. The process of continuously blowing air being supplied from a fan or other inflation device occurring at substantially the same rate as air escaping the fabric allows the display to maintain a three-dimensional shape without the use of an internal or external frame or structure. These are known in the industry as “cold-air” inflatable displays.

Typically, the cold-air inflatable display is a static figure formed from an inflation module which represents an individual figure when inflated. For example, a consumer may decide to decorate their house with a spider inflatable display for the Halloween season or a Santa Clause inflatable display for the holiday season. One of the limitations of the cold-air inflatable display is that they are static.

Presently disclosed embodiments overcome the limitations of the prior art.

### BRIEF DESCRIPTION OF THE FIGURES

FIGS. 1-2 depict an embodiment according to the present disclosure.

FIGS. 3-4 depict another embodiment according to the present disclosure.

FIG. 5 depicts a motorized assembly according to some embodiments presently disclosed.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

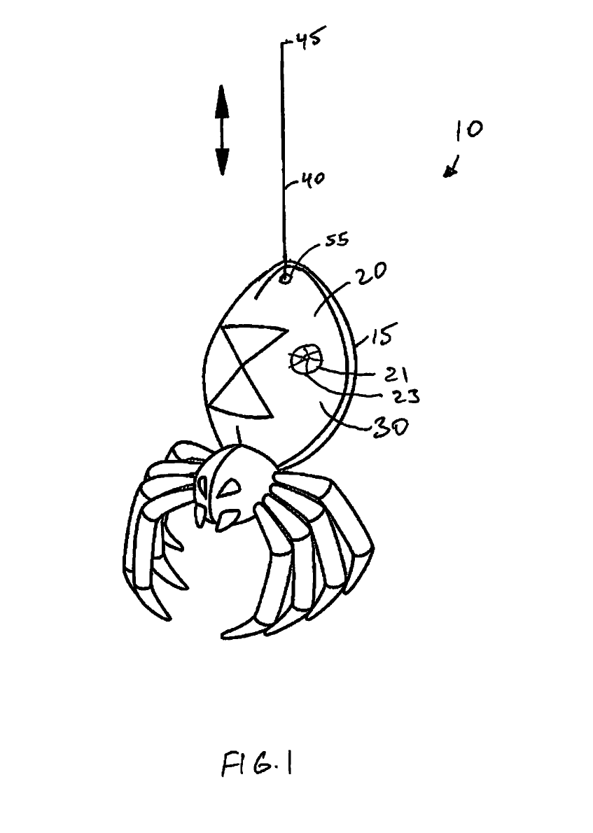

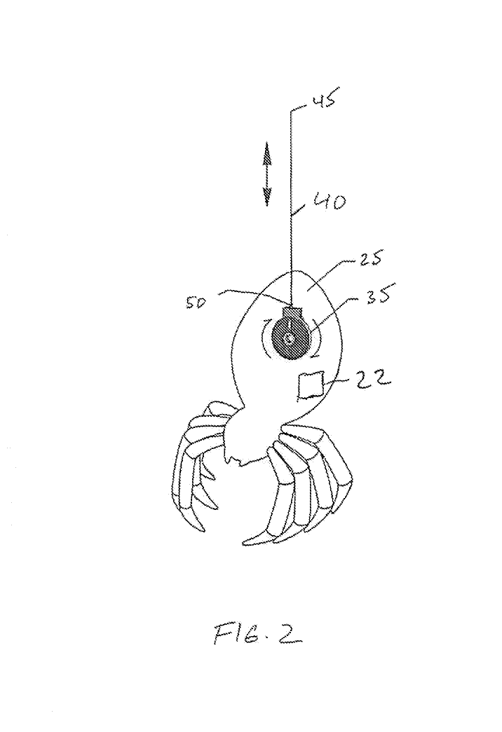

According to some embodiments, an inflatable display assembly 10 is shown in FIG. 1 and is presently disclosed. According to some embodiments, the inflatable display assembly 10 comprises an inflatable display 15. According to some embodiments, the inflatable display 15 comprises an inflatable outer shell 20. The inflatable outer shell comprises an interior surface 25 (shown in FIG. 2) and an outer surface 30 (shown in FIG. 1). FIG. 2 is a cutaway view of the inflatable display 15.

According to some embodiments, the inflatable display 15 comprises at least one fan 21 configured to inflate the inflatable outer shell 20. According to some embodiments, the at least one fan 21 comprises a motor/air pump 22 (shown in FIG. 2) and a grid 23 (shown in FIG. 1). According to some embodiments, the motor/air pump 22 is configured to pump outside air through the grid 23 to inflate the inflatable outer shell 20. According to some embodiments, the inflatable outer shell 20 comprises a permeable fabric that allows air to escape at about the same rate as the air being blown into the inflatable outer shell 20 by the at least one fan 21.

According to some embodiments, the motor/air pump 22 is coupled with the interior surface 25. According to some embodiments, the at least one fan 21 implemented as a lightweight plastic sleeveless bearing fan. According to some embodiments, the at least one fan 21 is removable and can be easily removed from its housing for cleaning or replacement whenever necessary.

According to some embodiments, the inflatable display assembly 10 comprises a motorized assembly 35 disposed within the inflatable display 15. According to some embodiments, the motorized assembly 35 is coupled with the interior surface 25. According to some embodiments, the inflatable display assembly 10 comprises a string 40. According to some embodiments, the string 40 comprised a first end 50 associated with the motorized assembly 35 and a second end 45. According to some embodiments, the motorized assembly 35 is configured to pull in (wind up) or let out (wind out) or otherwise adjust the tension of the string/rope 40.

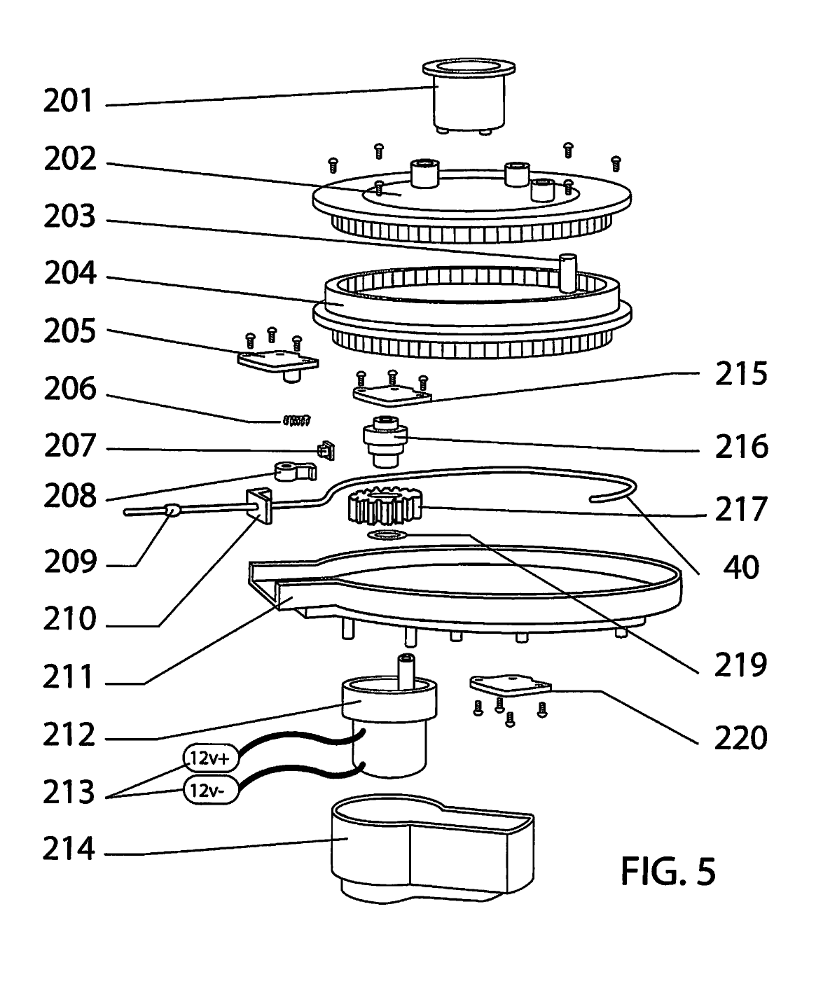

Referring to FIG. 5, according to some embodiments, the motorized assembly 35 comprises a pivot sleeve 201, a tope cover 202, a short tube 203, a big gear 204, a thread box cover 205, a spring 206, a switch 207, a cover 208, a bead 209, a lever 210, a bottom cover 211, a motor 212, one or more wires 213, a motor cover 214, a gear clamping plate 215, a clutch 216, a small gear 217, a rope 40, an O-ring 219, a power source, for example, one or more batteries (not shown), and a Printed Circuit Board Assembly (PCBA) with electronic parts 220.

According to some embodiments, the motorized assembly 35 is powered by the electric motor 212 connected to a power source (not shown). According to some embodiments, the motor 212 rotates gears 204, 216, 217 and turns the top cover 202 to roll the rope 40.

According to some embodiments, the bead 209 on the rope 40 is pulled down to hit the lever 210 and activate the switch 207, the PCBA 220 that controls the rotation of the motor 212 will then reverse the spin of the motor and the direction of movement of the rope 40 will also reverse. According to some embodiments, the clutch 216 engages and disengages the power transmissions an may be used to prevent the motor 212 from being damaged if the rope 40 was blocked.

According to some embodiments, a pull on the rope 40 may move the motorized assembly 35 up and the release of the rope 40 may move the motorized assembly 35 down. As the motorized assembly 35 is coupled with the inflatable display 15, the inflatable display 15 will move upward and downward accordingly.

According to some embodiments, the inflatable display 15 may be coupled to an object, like for example a tree, house, fence, etc. through the second end 45 of the string 40. According to some embodiments, the inflatable display 15 may travel up and down the string 40 using the motorized assembly 35.

According to some embodiments, the string 40 protrudes through the opening 55 in the inflatable outer shell 20. According to some embodiments, the at least one fan 21 is configured to blow air into the inflatable outer shell 20 at the substantially same rate as the air escapes through the permeable fabric of the inflatable outer shell 20 and the opening 55.

According to some embodiments, the inflatable display assembly 10 comprises a motion detector (not shown) associated with the motorized assembly 35. According to some embodiments, the motion detector (not shown) is configured to activate the motorized assembly 35 when motion is detected. According to some embodiments, the motion detector (not shown) is configured to have the motorized assembly 35 pull in the string 40 when motion is detected and to have the motorized assembly 35 let out the string 40 when the motion stops. According to some embodiments, the motion detector (not shown) is configured to have the motorized assembly 35 let out the string 40 when motion is detected and to have the motorized assembly 35 pull in the string 40 when the motion stops.

According to some embodiments, the inflatable display assembly 10 comprises a speaker (not shown) to play audio. According to some embodiments, the inflatable display assembly 10 comprises a processor (not shown) and a memory (not shown). According to some embodiments, the speaker (not shown) is configured to play one or more audio files stored in the memory (not shown). According to some embodiments, the speaker (not shown) is configured to play one or more audio files when the motorized assembly 35 pulls in the string 40. According to some embodiments, the speaker (not shown) is configured to play one or more audio files when the motorized assembly 35 lets out the string 40. According to some embodiments, the speaker (not shown) is configured to play one or more audio files received through a radio frequency (RF) circuitry (not shown and described in more detail below).

According to some embodiments, the inflatable display assembly 10 comprises a radio frequency (RF) circuitry (not shown). The RF circuitry (not shown) may be configured to receive and transmit RF signals, also called electromagnetic signals. The RF circuitry (not shown) converts electrical signals to/from electromagnetic signals and communicates with communications networks and other communications devices via the electromagnetic signals. The RF circuitry (not shown) may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry (not shown) may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

According to some embodiments, the RF circuitry (not shown) is configured to allow a user to activate the motorized assembly 35 from a remote location. According to some embodiments, the RF circuitry (not shown) is configured to have the motorized assembly 35 pull in the string 40 when receiving a first signal from the user and to have the motorized assembly 35 let out the string 40 when receiving a second signal from the user. According to some embodiments, the RF circuitry (not shown) is configured to have the motorized assembly 35 let out the string 40 when receiving a first signal from the user and to have the motorized assembly 35 pull in the string 40 when receiving a second signal from the user.

Although the inflatable display 15 is represented as a spider, it is to be understood that the inflatable display 15 can be any shape and/or size and is not limited to being only a spider. According to some embodiments, the inflatable display 15 is shaped as a human being, animal, insect, fictional character, geometric shape, building, structure or any other shape.

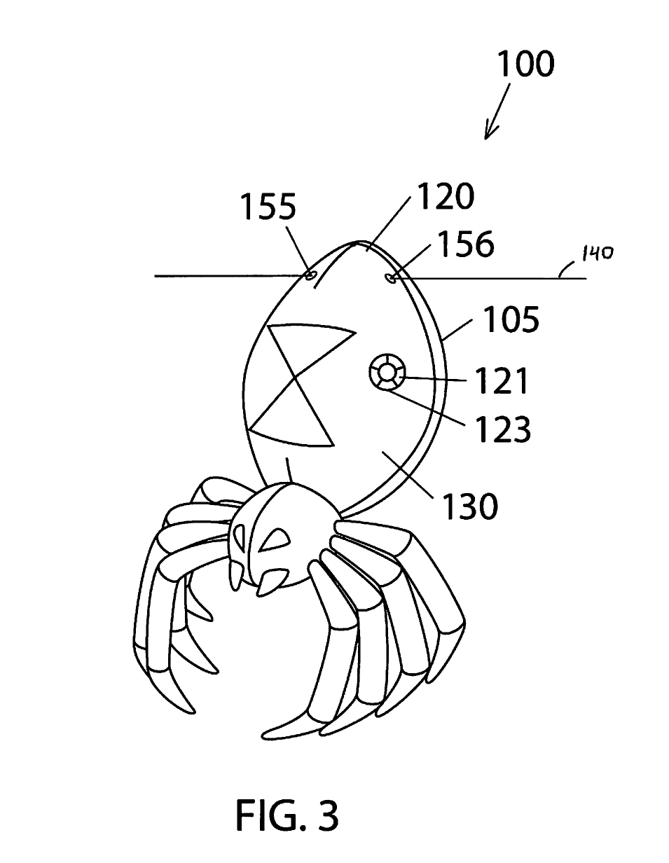

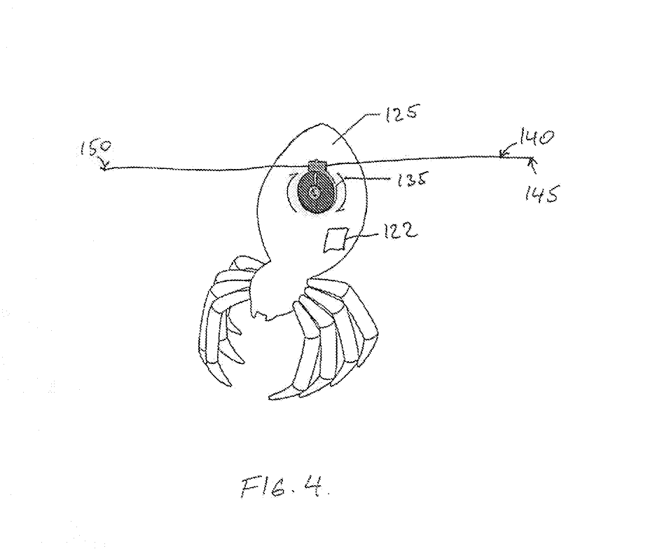

According to some embodiments, an inflatable display assembly 100 is shown in FIG. 3 and is presently disclosed. According to some embodiments, the inflatable display assembly 100 comprises an inflatable display 105. According to some embodiments, the inflatable display 105 comprises an inflatable outer shell 120. The inflatable outer shell 120 comprises an interior surface 125 (shown in FIG. 4) and an outer surface 130 (shown in FIG. 3). FIG. 4 is a cutaway view of the inflatable display 105.

According to some embodiments, the inflatable display 105 comprises at least one fan 121 configured to inflate the inflatable outer shell 120. According to some embodiments, the at least one fan 121 comprises a motor/air pump 122 (shown in FIG. 4) and a grid 123 (shown in FIG. 3). According to some embodiments, the motor/air pump 122 is configured to pump outside air through the grid 123 to inflate the inflatable outer shell 120.

According to some embodiments, the inflatable outer shell 120 comprises a permeable fabric that allows air to escape at about the same rate as the air being blown into the inflatable outer shell 120 by the at least one fan (not shown).

According to some embodiments, the motor/air pump 122 is coupled with the interior surface 125. According to some embodiments, the at least one fan 121 implemented as a lightweight plastic sleeveless bearing fan. According to some embodiments, the at least one fan 121 is removable and can be easily removed from its housing for cleaning or replacement whenever necessary.

According to some embodiments, the inflatable display assembly 100 comprises a motorized assembly 135 is disposed within the inflatable display 105. According to some embodiments, the motorizes assembly 135 is coupled with the interior surface 125. According to some embodiments, the inflatable display assembly 100 comprises a string 140. According to some embodiments, the string 140 comprised a first end 145 and a second end 150. According to some embodiments, the motorized assembly 135 is configured to pull in (move to the right) or let out (move to the left) or otherwise adjust the tension of the string 140. According to some embodiments, the motorized assembly 135 is configured to travel from first end 145 to the second end 150 and vise versa.

According to some embodiments, the inflatable display 105 may be coupled to an object, like for example a tree, house, fence, etc. through the first end 145 of the string 140 and may be coupled to anther object, like for example a tree, house, fence, etc. through the second end 150 of the string 140. According to some embodiments, the inflatable display 105 may travel along the string 140 using the motorized assembly 135.

According to some embodiments, the string 140 protrudes through the openings 155 and 156 in the inflatable outer shell 120. According to some embodiments, the at least one fan 121 is configured to blow air into the inflatable outer shell 120 at the substantially same rate as the air escapes through the permeable fabric of the inflatable outer shell 120 and the openings 155 and 156.

According to some embodiments, the inflatable display assembly 100 comprises a motion detector (not shown) associated with the motorized assembly 135. According to some embodiments, the motion detector (not shown) is configured to activate the motorized assembly 135 when motion is detected. According to some embodiments, the motion detector (not shown) is configured to have the motorized assembly 135 travel towards the end 145 of the string 140 when motion is detected and to have the motorized assembly 35 travel towards the end 150 of the string 140 when the motion stops. According to some embodiments, the motion detector (not shown) is configured to have the motorized assembly 135 travel towards the end 150 of the string 140 when motion is detected and to have the motorized assembly 135 travel towards the end 145 of the string 140 when the motion stops.

According to some embodiments, the inflatable display assembly 100 comprises a speaker (not shown) to play audio. According to some embodiments, the inflatable display assembly 100 comprises a processor (not shown) and a memory (not shown). According to some embodiments, the speaker (not shown) is configured to play one or more audio files stored in the memory (not shown). According to some embodiments, the speaker (not shown) is configured to play one or more audio files when the motorized assembly 135 pulls in the string 140. According to some embodiments, the speaker (not shown) is configured to play one or more audio files when the motorized assembly 135 lets out the string 140. According to some embodiments, the speaker (not shown) is configured to play one or more audio files received through a radio frequency (RF) circuitry (not shown and described in more detail below).

According to some embodiments, the inflatable display assembly 100 comprises a radio frequency (RF) circuitry (not shown). The RF circuitry (not shown) may be configured to receive and transmit RF signals, also called electromagnetic signals. The RF circuitry (not shown) converts electrical signals to/from electromagnetic signals and communicates with communications networks and other communications devices via the electromagnetic signals. The RF circuitry (not shown) may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry (not shown) may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

According to some embodiments, the RF circuitry (not shown) is configured to allow a user to activate the motorized assembly 135 from a remote location. According to some embodiments, the RF circuitry (not shown) is configured to have the motorized assembly 135 travel towards the end 145 of the string 140 when receiving a first signal from the user and to have the motorized assembly 135 travel towards the end 150 of the string 140 when receiving a second signal from the user. According to some embodiments, the RF circuitry (not shown) is configured to have the motorized assembly 135 travel towards the end 150 of the string 140 when receiving a first signal from the user and to have the motorized assembly 135 travel towards the end 145 of the string 140 when receiving a second signal from the user.

Although the inflatable display 105 is represented as a spider, it is to be understood that the inflatable display 105 can be any shape and/or size and is not limited to being only a spider. According to some embodiments, the inflatable display 105 is shaped as a human being, animal, insect, fictional character, geometric shape, building, structure or any other shape.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

What is claimed is:

1. An inflatable display comprising:
an inflatable outer shell;
at least one fan providing a continuous air flow to inflate the inflatable outer shell;
a motorized assembly disposed within the inflatable outer shell;
a string comprising a first end and a second end;
wherein the motorized assembly is configured to move the inflatable shell from a first position to a second position along the string;
wherein the first position is closer to the first end than the second position.

2. The inflatable display of claim 1, wherein the motorized assembly is removable.

3. The inflatable display of claim 1, wherein the first position is higher than the second position.

4. The inflatable display of claim 1, wherein the first end of the string is disposed outside of the inflatable outer shell and the second end of the string is disposed within the inflatable outer shell.

5. The inflatable display of claim 1, wherein the first end and the second end of the string are disposed outside of the inflatable outer shell.
